(19) United States
(12) Patent Application Publication
(10) Pub. No.: US 2011/0248923 A1
(43) Pub. Date: Oct. 13, 2011

(54) ADAPTIVE KEYBOARD LIGHT TURNER

(75) Inventors: Glen C. Larsen, Issaquah, WA (US); Neil Emerton, Redmond, WA (US); Anthony Christian Reed, Seattle, WA (US)

(73) Assignee: MICROSOFT CORPORATION, Redmond, WA (US)

(21) Appl. No.: 12/900,325

(22) Filed: Oct. 7, 2010

Related U.S. Application Data
(63) Continuation-in-part of application No. 12/757,734, filed on Apr. 9, 2010.
Application No. 12/757,734 is a continuation-in-part of application No. 12/841,046, filed on Jul. 21, 2010.

(51) Int. Cl. G06F 3/02

(52) U.S. Cl. 345/168

(57) ABSTRACT

An input device includes a display device configured to selectively modulate light to produce a changeable display image. The input device also includes a keyboard assembly disposed over the display device and including one or more depressible keys. Each depressible key includes a keycap having a light transmissive window and a light-turning feature or element between the display device and the keycap.

### CROSS REFERENCE TO RELATED APPLICATIONS

This application is a continuation-in-part of U.S. patent application Ser. No. 12/757,734, filed Apr. 9, 2010 and U.S. patent application Ser. No. 12/841,046, filed Jul. 21, 2010, which are hereby incorporated herein by reference.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular LCD display can be situated above the function keys or number pad.

Another approach to combining input and output capability in a peripheral device is the use of a virtual keyboard on a touch interactive display. Each key is displayed on the touch interactive display device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile feedback, which can provide a more responsive and agreeable typing experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, an input device includes a display device configured to selectively modulate light to produce a changeable display image. The input device also includes a keyboard assembly disposed over the display device and including one or more depressible keys. Each depressible key includes a keycap having a light transmissive window and a light-turning feature or element between the display device and the keycap.

### BRIEF DESCRIPTION OF THE DRAWINGS

FIG. 1 illustrates an exemplary computing system including a computer peripheral that provides the ability to display viewable output through the keys of a keyboard assembly.

FIG. 2 is an exploded view of the computer peripheral shown in FIG. 1, and shows viewable display output being provided by a display device underlying the keyboard assembly of the computer peripheral.

FIG. 3 illustrates an example of the output display capability that may be employed in connection with the computer peripheral of FIGS. 1 and 2.

FIGS. 4 and 5 are partial-section views of an embodiment of a key that may be employed in connection with the computer peripheral of FIGS. 1 and 2.

FIGS. 6 and 7 are bottom and top perspective views of an embodiment of a two-piece keycap, including a central transparent piece to facilitate through-key viewing of images produced by a display device underlying the keyboard assembly.

FIG. 8 illustrates an exemplary configuration for a keyboard assembly base structure having centrally offset tactile feedback structures.

FIG. 9 is a side view of a key which illustrates viewing considerations associated with through-key viewing of images.

FIGS. 10 and 11 are exploded views showing further exemplary key constructions including light pillars.

FIG. 12 schematically shows a light pillar coupled to a key of a keyboard assembly.

FIG. 13 schematically shows a light pillar coupled to a display device under a key of a keyboard assembly.

FIG. 14 schematically shows a light pillar with a negative optical power.

FIG. 15 schematically shows a light pillar with a positive optical power.

FIG. 16 schematically shows a portion of a light-turning layer in the form of a repeating array of microprisms.

FIG. 17 schematically shows a light pillar coupled to a display device under a key of a keyboard assembly.

FIG. 18 schematically shows a light pillar coupled to a key of a keyboard assembly.

FIG. 19 is an exploded view showing an exemplary key construction including a turning prism.

FIGS. 20-22 are partial-section views of keys including turning prisms.

### DETAILED DESCRIPTION

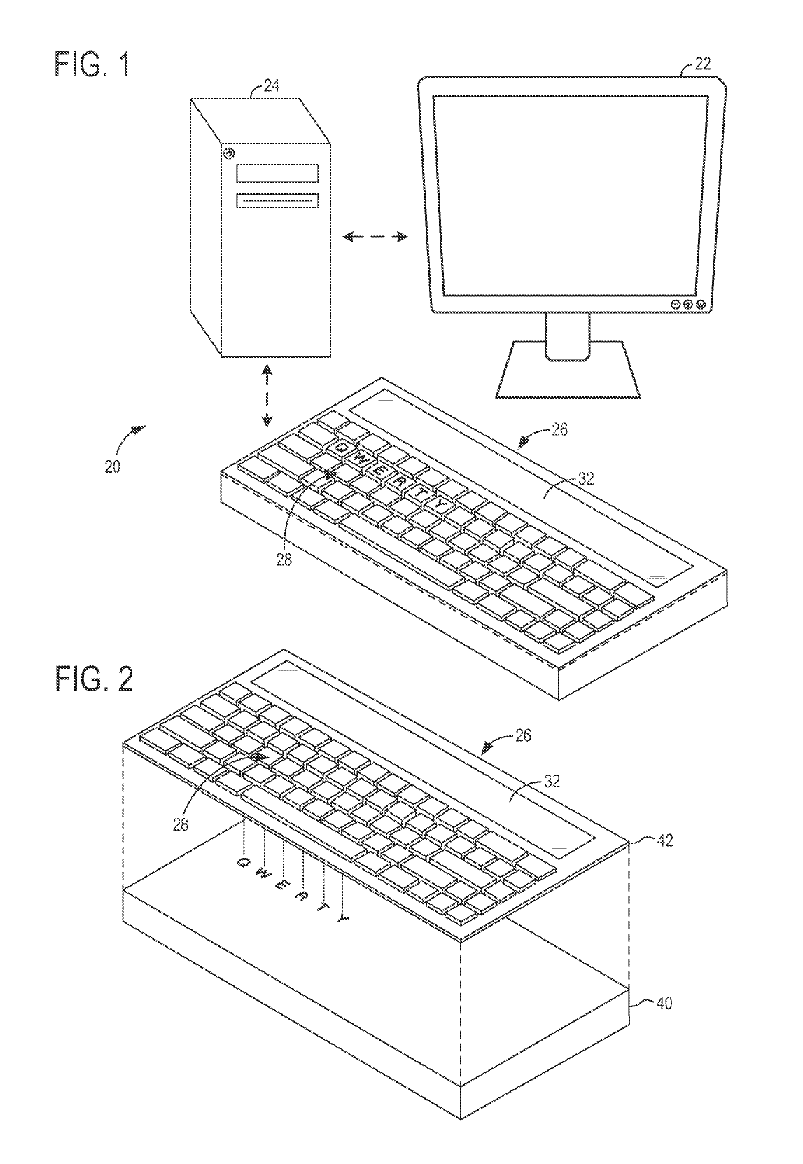

FIG. 1 depicts an exemplary computing system 20 including a display monitor 22, a component enclosure 24 (e.g., containing a processor, hard drive, etc.), and a computer peripheral 26. FIG. 2 provides an additional view of computer peripheral 26 and exemplary components that may be used in its construction. As will be described in various examples, computer peripheral 26 may be implemented to provide displayable output in addition to keyboard-type input functionality. Among other things, the computer peripheral may include keys employing a two-piece construction with transparent components to facilitate through-key viewing of images. The two-piece construction may also be employed to optionally conceal or reduce the visual impact of portions of the peripheral device that are not related to the display functionality. 100241 The terms “input” and “output” will be used frequently in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc. on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of software running on computing system 20. For example, upon pressing of an “ALT” key, the key that otherwise is used to enter the letter “F” might instead result in activation of a “File” menu in a software application. Generally, it should he understood that the keys in the present examples may be selectively depressed to produce any type of input signal for controlling a computer.

Computer peripheral 26 can provide a wide variety of displayable output to enhance and otherwise augment the computing experience. In some examples, the computer peripheral causes a display of viewable output on or near the individual keys 28 to indicate key function. This can be seen in FIGS. 1 and 2, where instead of keys with letters painted or printed onto the keycap surface, a display mechanism (e.g., a liquid crystal display (LCD) device situated under the keys) is used to indicate the “Q”, “W”, etc. functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based technology or other suitable methods.

Turning now to FIG. 2, computer peripheral 26 may include a display device 40 and a keyboard assembly 42 disposed over and coupled with the display device. A keyboard assembly in accordance with the present disclosure (e.g., keyboard assembly 42) may include one or more depressible keys. Keyboard assembly 42 may be at least partially transparent, to allow a user to view images produced by the display device through the keyboard assembly. In one embodiment, for example, each key 28 has a central transparent portion that allows a user to see the images produced by an LCD panel or other display device situated underneath keyboard assembly 42. In some cases, substantially all of the key will be transparent. In other examples, a periphery portion of the key may be opaque, for example to conceal structures that facilitate upward and downward movement of the keycap.

A variety of types of display device 40 may be employed. As indicated briefly above, one type of suitable display device is an LCD device. Indeed, LCD devices will be frequently referred to in the examples discussed herein, though this is non-limiting and it should be appreciated that the keyboard assembly may be coupled with a variety of other display types. In general, the display device may be configured to selectively modulate light to produce a changeable display image, portions of which may be presented through different keys.

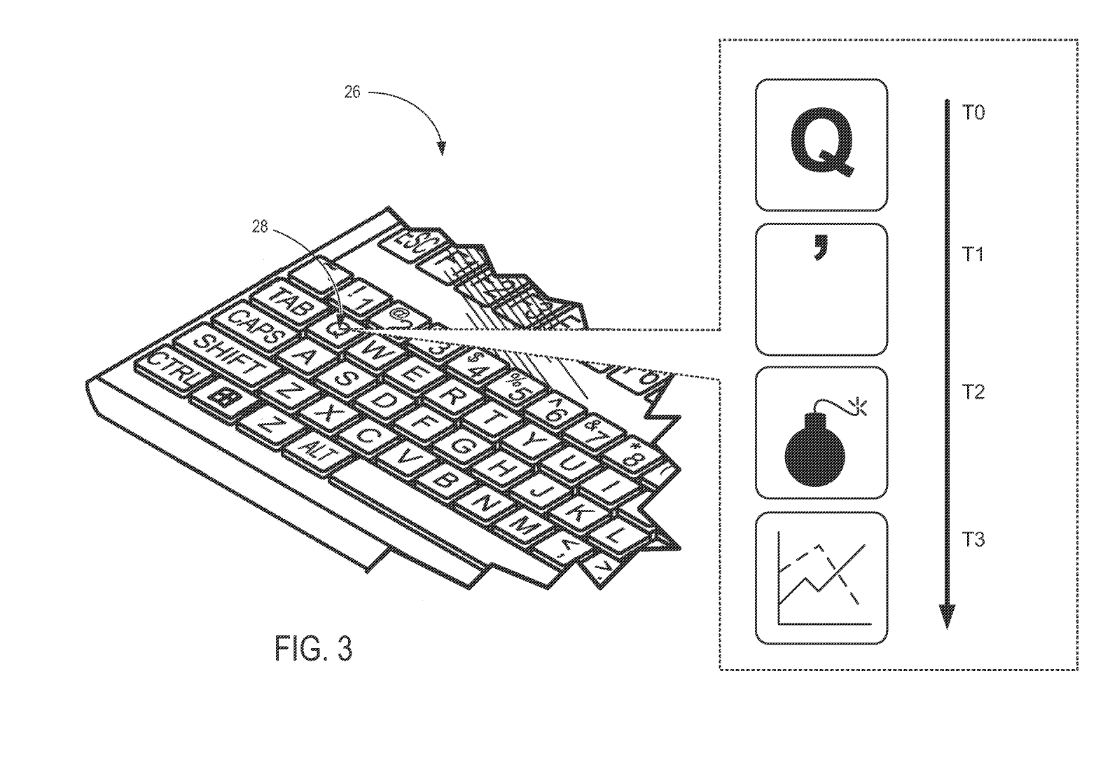

FIG. 3 provides further illustration of how the display capability of computer peripheral 26 may be employed in connection with an individual key 28. In particular, as shown respectively at times T₀, T₁, T₂, etc., the display output associated with key 28 may be changed, for example to reflect the input command produced by depressing the key. However, as previously mentioned, the viewable output provided by the computer peripheral may take forms other than displays associated with individual keys and their input functionality.

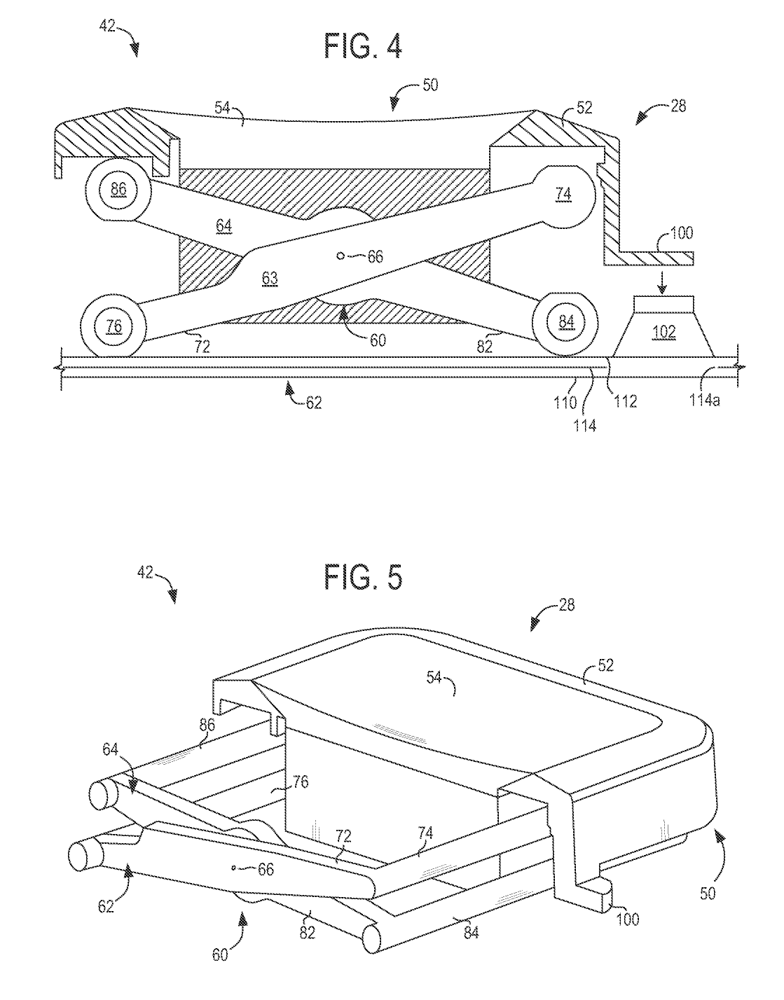

As in the examples of FIGS. 1 and 2, keyboard assembly 42 typically will include a plurality of keys employing some type of mechanism that enables the keys to be depressed or otherwise moved to produce an input signal. Although the term “keys” will be used primarily, this term is non-limiting, and should be understood to include buttons and any other structure or mechanism that may be moved by a user to provide input. FIGS. 4 through 11 show example structures that may be employed to implement individual keys of keyboard assembly 42.

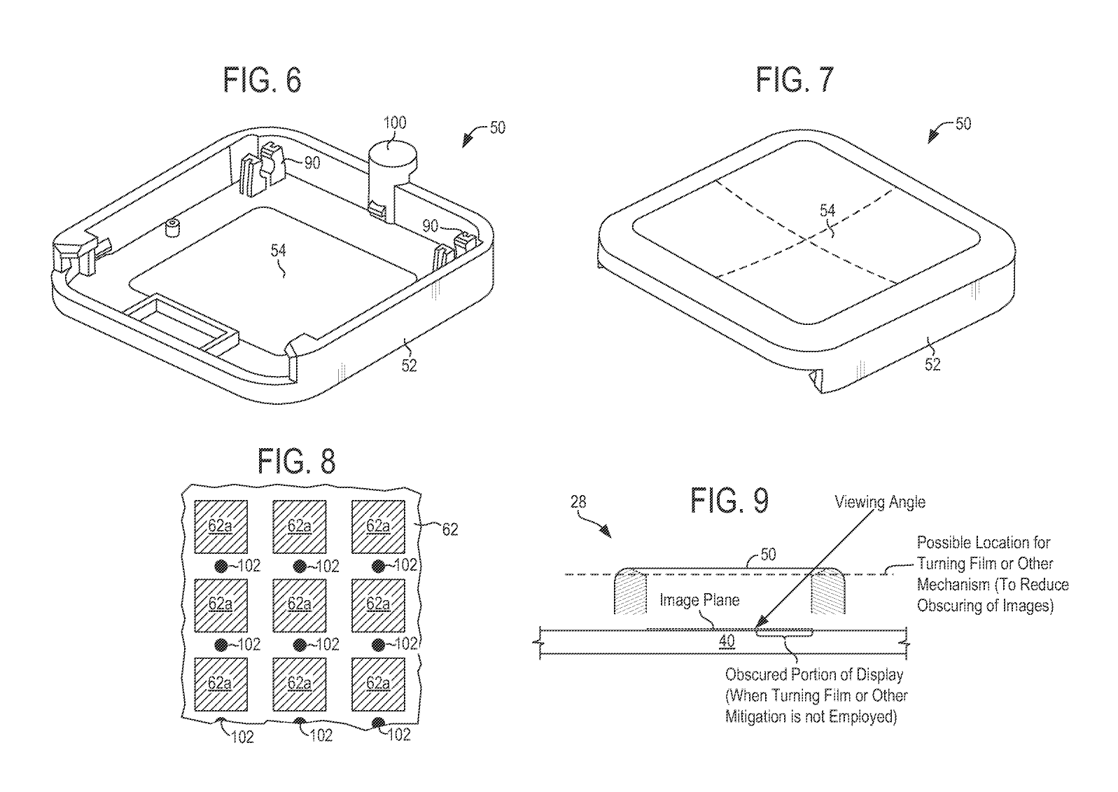

Referring now specifically to FIGS. 4 and 5, the figures show partial-section views of a portion of keyboard assembly 42, including an embodiment of an individual key 28. Key 28 includes a keycap 50 having a perimeter portion 52 and a central portion 54 in the form of a light transmissive window. In some constructions, perimeter portion 52 and central portion 54 are formed as separate distinct pieces, and will thus sometimes be referred to as a perimeter piece 52 and central piece 54. Many of these same structures may be seen in FIGS. 6 and 7, which respectively provide bottom and top perspective views of keycap 50.

A scissors structure 60 (FIGS. 4 and 5) is disposed between keycap 50 and a base structure 62 (FIG. 4) of keyboard assembly 42. The scissors structure is configured to enable movement of the keycap 50 upward and downward relative to the base structure 62. In particular, scissors structure 60 is configured to maintain the keycap 50 in alignment during movement and ensure that the movement is constrained to perpendicular linear movement toward and away from the base structure, without twisting, tilting, and the like. For example, it will generally be preferable that the top of the keycap remain parallel with base structure 62 during movement of the keycap.

Scissors structure 60 may include two portions 63 and 64 that pivot relative to one another via pivot point 66. Each portion includes a pair of opposed webs with a pair of rods extending between the webs. Specifically, scissor portion 63 includes web 72. Rod 74 extends from a first end of web 72; rod 76 extends from a second end of web 72. The rods extend to an opposing similar web structure that cannot be seen in FIG. 5 due to concealment by keycap 50. The other scissor portion 64 includes similar structures: web 82, rods 84 and 86, and an opposing web structure that is concealed in FIG. 5.

Scissors structure 60 may be variously configured and formed from a variety of different materials. In some embodiments, the entire structure may be plastic. It may be desirable in other examples to form some or all of the parts from metal. In particular, some embodiments employ plastic webs that are over-molded around metal connecting rods. Such use of metal rods may be advantageous when stiffness and rigidity are of particular concern, for example in the case of large format keys (e.g., the “shift” key or “spacebar” key of a keyboard).

It will be appreciated that the portions of the scissors structure 60 pivot relative to one another when the key is depressed downward toward base structure 62. The pivoting action results in an overall lowering of the scissors structure, and produces a slight increase in the effective length of the scissors structure. To accommodate this length variation, the scissors structure may be coupled with adjoining structures in a way that allows for some lateral movement. Referring specifically to the example of FIG. 4, the portions of scissors structure 60 are engaged with keycap 50 and base structure 62 as follows: A) Rod 74 is snapped into a pair of snap hooks 90 (shown in FIG. 6 but not in FIGS. 4 and 5) provided on the underside of keycap 50. This engagement allows rotation of the rod, as will occur during depression of the key, but maintains the lateral position of the rod relative to the keycap. B) Rod 86 abuts the underside of keycap 50, but is allowed to slide somewhat laterally during depression of the key, to accommodate the effective lengthening of the scissors structure that occurs during collapse. C) Rod 84 is held by a pair of snap hooks (not shown) on base structure 62, while rod 76 abuts the base structure but is permitted to slide laterally relative to the base structure. Similar to rods 74 and 86, this arrangement holds the scissors structure generally in place while allowing for the effective length variation that occurs during the pivoting operation of the scissors structure.

With reference to FIG. 5, it will be appreciated that the scissors structure may be disposed to the periphery of each key, thereby leaving the central area of the key unobstructed and maximally available for display purposes. In particular, when keycap 50 is viewed straight on from the top of the key, the webs and rods of the scissors structure are all positioned at the periphery of the key, underneath perimeter piece 52 of the keycap. Thus, when an LCD or other display device is employed under the keyboard assembly, the peripherally-configured scissors structures allow for a greater portion of the display to be viewed without obstruction through the key (i.e., through transparent central piece 54).

Continuing with FIGS. 4 through 7, other structures and mechanisms may be employed in connection with the actuation of the key. In the present example, as keycap 50 is depressed toward base structure 62 (FIG. 4), a plunger or tab-like protrusion 100 will depress a tactile structure, such as tactile feedback dome 102 (FIG. 4), which is associated with the key. As the key moves from the rest position toward its fully depressed state, the tactile feedback dome will eventually collapse and cause a palpable change in the action or feel of the key. In addition to collapsing the feedback dome, the depression of the key causes occurrence of an electrical event which produces the input signal or command associated with the key. In one example, a three-layer construction is used on base structure 62, in which conductors 110 and 112 are separated by insulating layer 114. The layers collectively form a switch mechanism. In particular, depression of the key and collapse of the tactile feedback dome causes conductors 110 and 112 to contact each other through a hole 114a in insulating layer 114, thus establishing an electrical connection which produces the input signal.

Regardless of the exact mechanism by which the signal is generated, use of a tactile structure provides tangible, haptic feedback which affirms that the user's physical movement (i.e., pressing of the key) has in fact sent the desired input signal to the attached computer. The tactile structures may be implemented as tactile feedback domes formed from metal or silicone, or other rubber-like dome structures, to name but a few possible examples. Selection of a particular type of tactile structure may be informed by tradeoffs and considerations relating to key feel, keyboard thickness, display performance, manufacturing concerns, robustness, reliability and the like. As will be described in more detail below, display performance can be enhanced in certain embodiments by having a thinner keyboard assembly. Tactile feedback domes made of metal can often be employed to reduce the keyboard assembly thickness (relative to other types of domes), however in some cases these domes are less desirable from a tactile feel standpoint. Conversely, a rubber-like tactile dome may provide the desired feel or action for the keyboard, but at the expense of an increased thickness which can affect the display performance.

FIG. 8 shows an exemplary arrangement of tactile structures on or in relation to base structure 62. Specifically, the figure shows a portion of base structure 62 corresponding to a region containing nine square-format keys, for example, from a central portion of the keyboards shown in FIGS. 1-3. For clarity of illustration, the keys themselves are not shown in the figure. The hatched regions indicate holes 62a in the base structure 62. These holes are generally aligned with the transparent central portions of the keycaps (e.g., central transparent pieces 54—shown in FIGS. 4-7), to facilitate viewing through the keyboard assembly to the underlying display device. The figure also shows that the tactile structure for each key (e.g., tactile feedback dome 102) is offset from the central display portion of the key, so as to not interfere with the display functionality. Indeed, similar to the scissors structure configuration discussed in connection with FIGS. 4 and 5, the tactile structures are positioned at the periphery of the keys so as to maximize use of the central portion of the key for display. In addition to or instead of holes 62a, base structure 62 may be constructed from a transparent material to facilitate the display capability. Also, the base structure may include a rigid piece or expanse to retain and/or support the key structures, and a separate flexible portion containing the insulating and conducting layers that provide the above-described electrical switching and connectivity.

As an alternative to the depicted arrangement, the tactile structures may be provided in other locations that do not impede display of images through the keycaps. For example, the tactile structure may be provided at a top or side edge of the holes in the base structure, as opposed to a bottom edge. Furthermore, tactile structures may be positioned underneath the scissors assembly such that they are compressed by actuation of the scissors assembly. Regardless of the particular configuration, the centrally offset position of the tactile structures will often be desirable in that it minimizes or eliminates the possibility of interfering with the through-key display functionality.

As discussed throughout, various considerations can arise relating to the viewing of images produced by display device 40 (FIG. 2). Some of these considerations relate to the fact that in the typical arrangement, the image source (i.e., display device 40) is located under keyboard assembly 42. The user therefore looks “through” the keyboard assembly to see the images. On the other hand, some portions of the keyboard assembly may not be transparent for various reasons, and it may be desirable to configure such “non-display” portions of the keyboard so that they do not detract from or otherwise impede the display functionality.

In some cases, it may be desirable to implement a display device in which the image plane is beneath the keys, at the surface of the display device. This is in contrast to a method involving projection of the image plane to a location on top of the keys, at some distance above the surface of the display device. Referring to FIG. 9, the figure shows a simplified schematic of key 28 disposed over display device 40. The keycaps and related structures have a thickness (e.g., between 2 and 10 millimeters), and therefore there is a potential for a “tunnel” effect through the center of each key, in which the user is looking through a rectangular tube to see the image associated with the key. Given an approximate viewing angle of 35-45 degrees, the thickness of the key results in a significant portion of the image plane being obscured, as indicated in the figure. This effect may be remediated to some extent through the use of turning films and/or prisms employed in the central portion of the key to increase the visible display area of the underlying display device.

The obscuring of the display may be mitigated to some extent through use of turning films and/or prisms employed in the central portion of the key. In particular, it will be desirable in some embodiments to employ a turning element in connection with the keycap. It will often be desirable that the turning element be employed near the top of the key, for example near the upper surface of the keycap 50. Light rays from the underlying display device would then be refracted toward the user at a point near the top of the key. Because the refraction is occurring near the top of the key, the sidewall portions of the key will obscure less of the display. FIG. 9 indicates a potential location for employing a turning film or prism. When employed, a turning film section or layer may be co-molded with the keycap, or may be joined to the keycap via adhesive, snap-fitting, ultrasonic-welding or any other suitable joining method. In addition to or instead of a turning film, the turning element may be implemented with a turning prism. As with the turning film, the turning prism may be implemented so that the point of refraction is near the top of the key.

As indicated above, the keys of the computer peripheral will typically be employed so that the central portion of each keycap is transparent, allowing the user to see images from the display device through the keycap. As previously discussed, it will often be desirable to configure supporting mechanical components (e.g., the scissors structure) so that they are located at the periphery of the key, so as to not block images being viewed through the central portion of the key. Furthermore, for aesthetic and other reasons, in some cases the peripheral portion of the keycap will be made opaque in order to conceal the scissors structure (e.g., to provide a cleaner aesthetic look and/or to prevent visual distractions that might take focus away from the images being provided by the display device).

One approach to providing opacity at the periphery while permitting light/images to pass through the center is to form the keycap as a single transparent piece and then paint the periphery of the keycap. Precision painting operations can be difficult, however, and particularly so when performed in mass production settings with small parts. Also, the painting operation is a separate step that can increase the time and cost of manufacturing. Accordingly, in some cases it will be advantageous to form a two piece keycap in which the central portion and the perimeter portion are separate. The above-described examples discussed with respect to FIGS. 4 through 7 all provide examples of such a two-piece keycap construction.

Separate-piece constructions for keycap 50 may be achieved in a variety of ways. In some embodiments, central piece 54 and perimeter piece 52 are molded or otherwise formed separately, and then affixed to one another in a separate joining step. Attachment may be achieved via snap fitting, adhesive (e.g., pressure-sensitive adhesive), ultrasonic welding, or any other suitable joining method. Alternatively, the two pieces may be formed as separate distinct pieces, but in a co-molding process, in which one of the pieces is molded first, and then the second piece is molded onto or over the first.

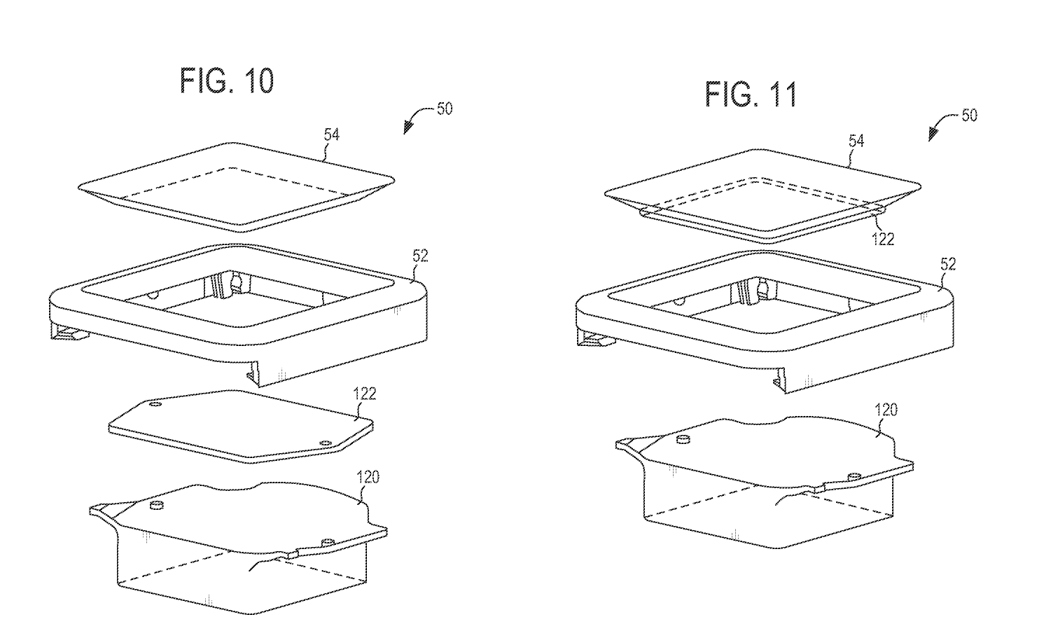

FIGS. 10 and 11 are exploded views which provide further examples of keycaps 50 employing a two-piece construction in which central piece 54 and perimeter piece 52 are separate pieces. Both examples show use of an optional light pillar 120, which may be located in the central viewing area of the key under the light transmissive window of the keycap and above the display device. In some settings, use of a light pillar can reduce the tunnel effect described above by creating a perception that the image plane is raised off of the underlying display device. In addition to or instead of a light pillar, a prism may be employed to turn light from the display device toward the user, so as to increase the effective size of the viewable display (i.e., by countering the display reduction resulting from the user's viewing angle). In combination with or separately from a prism, a turning film 122 may be employed to counter the viewing angle effect.

In the example of FIG. 10, the central piece 54, perimeter piece 52, turning film 122 and light pillar 120 are separate pieces that are joined together. Assembly and construction is similar in FIG. 11, except that the depicted embodiment shows use of a co-molded construction for perimeter piece 52, central piece 54, and turning film 122.

As shown by way of example in FIGS. 10 and 11, a light pillar may be coupled to a keycap. In such embodiments, the light pillar moves with the keycap when the keycap is depressed. A light pillar may be coupled to a keycap in any suitable manner. As nonlimiting examples, a light pillar may be snap fit to the keycap; a light pillar may be coupled to the keycap via an ultraviolet curable adhesive; or a light pillar may be coupled to the keycap via a pressure sensitive adhesive.

In other embodiments, a light pillar may be coupled to the display device and/or another stationary structure under the keycap. In such embodiments, the light pillar does not move with the keycap when the keycap is depressed. A light pillar may be coupled to a display device in any suitable manner. As nonlimiting examples, a light pillar may be coupled to the display device via an ultraviolet curable adhesive or a pressure sensitive adhesive. In such base-mounted arrangements, each light pillar may be one of a plurality of light pillars that collectively constituting a common piece coupled to the display device. In other words, a single piece may be manufactured to include a different light pillar for each key. In some embodiments, each light pillar may be two-shot molded to an opaque baseplate.

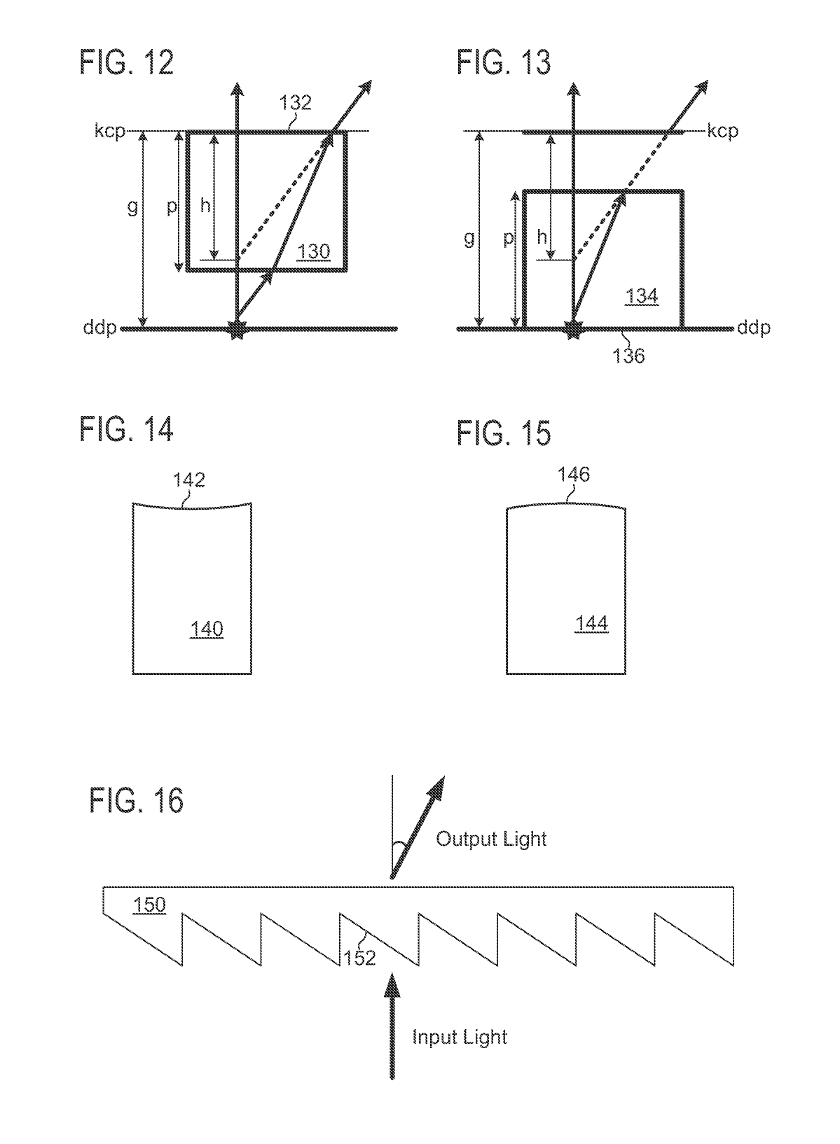

FIG. 12 schematically shows an example arrangement where a light pillar 130 is coupled to a keycap 132. FIG. 13 schematically shows an example arrangement where a light pillar 134 is coupled to a display device 136. In both drawings, kcp is the plane of the keycap; ddp is the plane of the display device; g is the distance between kcp and ddp; p is the height of the light pillar; and h is the apparent image distance under the keycap. In the below equations, n is the refractive index of the light pillar.

For the arrangement shown in FIG. 12:

h=[(g−p) tan(θ)+p tan(a sin(sin(θ)/n))]/tan(θ);

or to the first order:

h=g−p(n−1)/n.

For the arrangement shown in FIG. 13:

h=[p tan(θ)+(g−p) tan(a sin(sin(θ) n))]/tan(a sin(sin(θ) n));

or to the first order:

h=g−p(n−1)/n.

As such, the apparent image distance from the keycap is substantially the same in both configurations. To the first order, the image distance is the same. To the third order and beyond, there will be slightly less apparent distortion with a light pillar that is coupled to the display device instead of the keycap. However, this difference is likely to be very small and not discernable to a viewer.

In either configuration, the apparent image distance from the keycap decreases as the refractive index of the light pillar (n) increases and/or as the height of the light pillar (p) increases.

As such, it may be beneficial to use the tallest feasible light pillar (i.e., increase p). The light pillar may be sized to occupy substantially an entire distance between the keycap and the display device when the keycap is depressed. In other words, the light pillar may be sized so that only a very small air gap exists between the light pillar and the display device (FIG. 12) or the light pillar and the keycap (FIG. 13) when the keycap is depressed. In general, this air gap should be large enough to accommodate manufacturing tolerances to ensure that the keycap can be depressed without obstruction. As a nonlimiting example, a minimal air gap may be between 0.1 millimeter and 1 millimeter when the keycap is fully depressed.

Furthermore, it may be beneficial to construct the light pillar from a material with the highest feasible refractive index. In general, a higher refractive index of the light pillar will result in a greater reduction of the tunnel effect described above. A light pillar in accordance with this disclosure may be constructed from a material having a relatively high refractive index. In some embodiments, the light pillar may have a refractive index between 1.4 and 1.7 (e.g., refractive index of approximately 1.492 for acrylic plastic or refractive index of approximately 1.586 for polycarbonate).

In some embodiments, the light pillar may have an optical power allowing the light pillar to magnify or de-magnify a portion of the image created by the display device. In the case of magnification, a relatively smaller portion of the display device may be used to form the image for each key, and the light pillar may magnify this portion. In this way, relatively fewer pixels are used to form the image on each key. In the case of de-magnification, a relatively larger portion of the display device may be used to form the image for each key, and the light pillar may de-magnify this portion. In this way, relatively more pixels are used to form a higher resolution image on each key.

As schematically shown with reference to FIG. 14, a light pillar 140 may include one or more concave faces (e.g., concave face 142) configured to de-magnify a portion of the changeable display image. As schematically shown with reference to FIG. 15, a light pillar 144 may include one or more convex faces (e.g., convex face 146) configured to magnify a portion of the changeable display image. In the illustrated embodiments, only a top face of the light pillar is shaped for optical power. However, it is to be understood that the bottom face additionally or alternatively may be shaped for optical power. 100611 As introduced with reference to FIGS. 10 and 11, in some embodiments, each key may further include a light-turning layer between the light pillar and the keycap. FIG. 16 schematically shows an enlarged view of a portion of such a light-turning layer. In the illustrated embodiment, light-turning layer 150 includes a repeating array of microprisms. Each microprism has an input facet (e.g., input facet 152) that receives input light. As light travels into, through, and out of the light-turning layer, the direction of the light is turned.

The degree to which light is turned can be controlled by the angle of the input facets of the microprisms and/or by the refractive index of the light-turning layer. In some embodiments, the light-turning layer is configured to turn the light by approximately 20 degrees, thus directing the light more directly at a user that is using the input device. In other embodiments, the light-turning layer can be configured to turn the light by a different amount. In general, higher turn angles may result in increased reflection losses and/or increased ghost images.

The light-turning layer may be coupled to the keycap or to the optical pillar. The light pillar may be spaced apart from the light-turning layer and/or have a different refractive index than the light-turning layer in either configuration, thus allowing input light to refract when entering the light-turning layer.

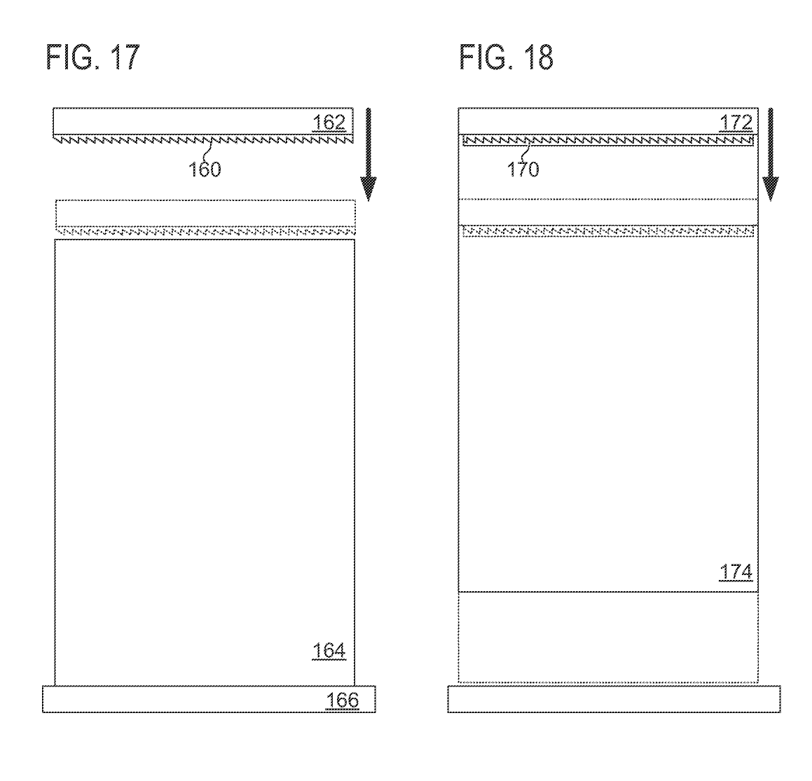

FIG. 17 schematically shows an embodiment in which a light-turning layer 160 is coupled to a keycap 162. In this embodiment, light pillar 164 is coupled to display device 166 and does not move with keycap 162 as the keycap is depressed. Keycap 162 and light-turning layer 160 are shown in the depressed position in dashed lines.

FIG. 18 schematically shows an embodiment in which a light-turning layer 170 is coupled to a keycap 172. In this embodiment, light pillar 174 is also coupled to keycap 172 and moves with keycap 172 as the keycap is depressed. Keycap 172, light-turning layer 170, and light pillar 174 are shown in the depressed position in dashed lines. In this embodiment, a small air gap between light-turning layer 170 and light pillar 174 ensures there is an optical index difference around the microprisms, thus enabling an optical turning effect.

In some embodiments, each key may include a mechanism for turning light that does not include a plurality of microprisms. As one example, each key may include a light-turning layer in the form of a single turning prism. Such a turning prism may be implemented with or without a light pillar.

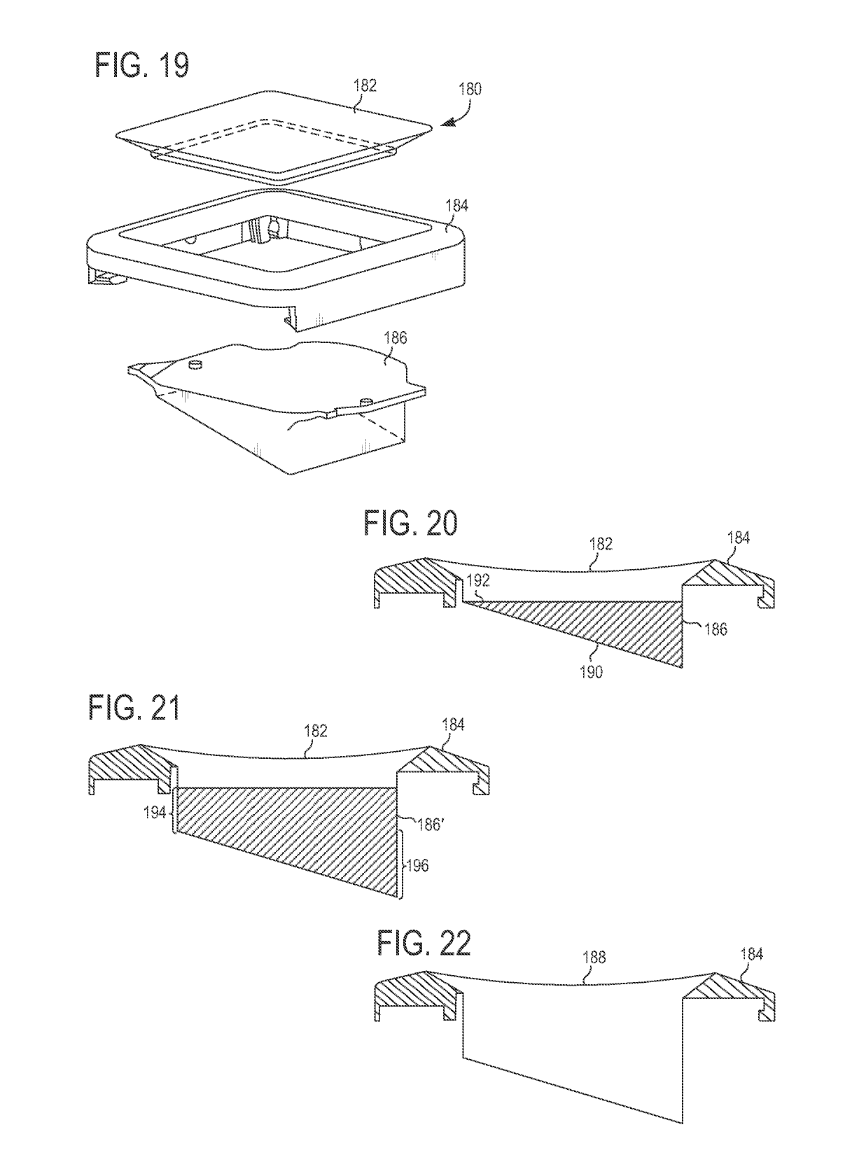

FIGS. 19-22 show nonlimiting examples of depressible keys that include turning prisms in accordance with the present disclosure. In comparison to the repeating array of microprisms depicted in FIG. 16, the turning prisms of FIGS. 19-22 span an entire distance across the light-transmissive window through which images from the underlying display device are passed. Such an arrangement may reduce stray light and image ghosting. Such an arrangement is also thicker than a comparable repeating array of microprisms.

As an example, FIG. 19 is an exploded view showing a keycap 180 employing a two-piece construction in which central piece 182 and perimeter piece 184 are separate pieces. Keycap 180 further includes a turning prism 186, which may be located in the central viewing area of the key under the light transmissive window of the keycap and above the display device. The turning prism 186 may be used to turn light from the display device toward the user, so as to increase the effective size of the viewable display (i.e., by countering the display reduction resulting from the user's viewing angle).

In the examples of FIGS. 19-21, the central piece 182, perimeter piece 184, and turning prisms 186 and 186′ are separate pieces that are joined together. Assembly and construction is similar in FIG. 22, except that the depicted embodiment shows use of an integral prism 188 in which the central piece and the turning prism are co-molded as a single piece. In other embodiments, an integral prism may further integrate the perimeter piece as part of the unified construction.

In general, a turning prism may be coupled to or integrated with a keycap in any suitable manner. As nonlimiting examples, a turning prism may he snap fit to the keycap; a turning prism may be coupled to the keycap via an ultraviolet curable adhesive; a turning prism may be coupled to the keycap via a pressure sensitive adhesive, or a turning prism may be integrated into another aspect of the key.

Using FIG. 20 as an example, turning prism 186 may include a single light-receiving face 190, which may be substantially planar. The light-receiving face 190 is positioned to receive light from an underlying display device, such as a liquid crystal display. Unlike a repeating array of microprisms, the light-receiving face is uninterrupted and substantially continuous.

The turning prism 186 further includes a light-outputting face 192. Light-receiving face 190 is skewed relative to light-outputting face 192. The amount of skew can be selected based on the desired amount light is to be turned and/or the space available for the turning prism. In general, steeper skew angles may provide more light turning at the cost of occupying more space. In some embodiments, a skew angle of approximately ten to twenty degrees may be used. Because the light-receiving face is angled relative to the light-outputting face, the light-receiving face has a greater area than the light-outputting face.

In addition to the skew angle, the degree to which light is turned can be controlled by the refractive index of the turning prism. The turning prism may have a refractive index between 1.4 and 1.7 (e.g., refractive index of approximately 1.492 for acrylic plastic or refractive index of approximately 1.586 for polycarbonate). In some embodiments, the turning prism is configured to turn the light by approximately 20 degrees, thus directing the light more directly at a user that is using the input device. In other embodiments, the turning prism can be configured to turn the light by a different amount.

As shown in FIG. 20, a turning prism may be shaped to occupy a relatively small space, thus providing room for a relatively long key depression. As shown in FIG. 21, a turning prism may alternatively include a light pillar portion 194 in addition to a prism portion 196. The light pillar portion 194 may reduce the tunnel effect described above by creating a perception that the image plane is raised off of the underlying display device.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An input device, comprising:
a display device configured to selectively modulate light to produce a changeable display image; and
a keyboard assembly disposed over the display device and including one or more depressible keys, each depressible key including:
a keycap having a light transmissive window; and
a light-turning layer between the display device and the keycap.

2. The input device of claim 1, where the light-turning layer is a prism.

3. The input device of claim 2, where the prism includes a single light-receiving face.

4. The input device of claim 3, where the light-receiving face of the prism is substantially planar.

5. The input device of claim 4, where the light-receiving face of the prism is skewed relative to a light-outputting face of the prism.

6. The input device of claim 5, where the light-receiving face of the prism is skewed by ten to twenty degrees relative to the light-outputting face of the prism.

7. The input device of claim 2, where the light-receiving face of the prism has a greater area than a light-receiving face of the keycap.

8. The input device of claim 2, where the prism is coupled to the keycap and moves with the keycap if the keycap is depressed.

9. The input device of claim 8, where the prism is snap fit to the keycap.

10. The input device of claim 8, where the prism is coupled to the keycap via an ultraviolet curable adhesive.

11. The input device of claim 8, where the prism is coupled to the keycap via a pressure sensitive adhesive.

12. The input device of claim 2, where the prism is light transmissive with a refractive index between 1.4 and 1.7.

13. An input device, comprising:
a display device configured to selectively modulate light to produce a changeable display image; and
a keyboard assembly disposed over the display device and including one or more depressible keys, each depressible key including:
a keycap having a light transmissive window; and
a prism coupled to the keycap between the display device and the keycap such that the prism moves with the keycap if the keycap is depressed.

14. The input device of claim 13, where the prism includes a single, substantially planar, light-receiving face that is skewed relative to a light-outputting face of the prism.

15. The input device of claim 14, where the light-receiving face of the prism is skewed by ten to twenty degrees relative to the light-outputting face of the prism.

16. The input device of claim 13, where the prism is snap fit to the keycap.

17. The input device of claim 13, where the prism is coupled to the keycap via an ultraviolet curable adhesive.

18. The input device of claim 13, where the prism is coupled to the keycap via a pressure sensitive adhesive.

19. The input device of claim 13, where the prism is light transmissive with a refractive index between 1.4 and 1.7.

20. An input device, comprising:
a display device configured to selectively modulate light to produce a changeable display image; and
a keyboard assembly disposed over the display device and including one or more depressible keys, each depressible key including a keycap, and each keycap including an integral prism configured to turn light received from the display device.
